(19) United States
(12) Patent Application Publication
(10) Pub. No.: US 2008/0164302 A1
(43) Pub. Date: Jul. 10, 2008

(54) Hanging file folder

(76) Inventor: Chin-Lien Ho, Taichung City (TW)

Correspondence Address: CHARLES E. BAXLEY, ESQ., 90 JOHN STREET, THIRD FLOOR, NEW YORK, NY, 10038, US

(21) Appl. No.: 11/650,139

(22) Filed: Jan. 4, 2007

(51) Int. Cl. B42F 15/00

(52) U.S. Cl. 229/67.2

(57) ABSTRACT

The present invention is related to a hanging file folder, which has a suspension bar and two adjusting structures respectively attached to the opposite ends thereof wherein each of the adjusting structures is attached by a collapsible hook. When the hooks of the disclosed hanging file folder are extended, the folder can be hung upon two parallel support rails of a hanging file frame assembly, whereas the hooks can be collapsed for facilitating general application. Additionally, the suspension bar of the present invention can be accommodated to folders of different sizes by setting the length of adjusting structures appropriately.

### BACKGROUND OF THE INVENTION

1. Technical Field

The present invention relates to file folders for holding loose papers and, more particularly, to a hanging file folder.

2. Description of Related Art

As shown in FIGS. 1 and 2, a conventional hanging file folder typically comprises a body portion 90 made by folding up a paper or plastic board whereon a fold 91 is formed. A seal line 92 is made near and in parallelism with the fold 91 to fasten the covers 901, 902 together and therefore a suspension-bar-receiving channel 93 is bounded between the fold 91 and the seal line 92 wherein a suspension bar 94 having two stationary hooks 95 relatively integrated with the opposite ends thereof can be received in the manner that the hooks 95 are permanently jutting out from two opposite edges 903, 904 of the body portion 90. Further, each said hook 95 comprises a downward-opened indentation 96 for matching either parallel support rail of a hanging file frame assembly. Accordingly, such conventional hanging file folder is advantageous by facilitating arranging and acquiring folders.

However, as the two stationary hooks 95 of the conventional hanging file folder are permanently jutting out from two opposite edges 903, 904, they can either disturb a user or be easily damaged by impact during the user's paging or filling the folder.

Meantime, such conventional hanging file folder may have a further disadvantage that diverse molds are required for making suspension bars 94 at diverse lengths for diverse-sized folders, such as common A3 folders, A4 folders or folders of custom-made dimensions, and this consequently consumes considerable manufacturing costs.

### SUMMARY OF THE INVENTION

It is one objective of the present invention to provide an improved hanging file folder that distinctively comprises a pair of collapsible hanging hooks that can be engaged with two parallel support rails of a hanging file frame assembly when being fully extended and can be collapsed for avoiding disturbing the user or being damaged by possible impact.

It is another objective of the present invention to provide a hanging file folder that is adaptable to diverse-sized folders so as to eliminate the need for preparing diverse molds and facilitate retrenching manufacturing costs.

To achieve these and other objectives of the present invention, the hanging file folder comprises:

a body portion, which is composed of two opposite covers and a spine jointing situated between the adjoining edges thereof;

a suspension bar, which is fastened between the covers by a plurality of fasteners near the spine, and is attached by two adjusting structures at the opposite ends thereof; and

two hooks, each having one end connected to one of the adjusting structures by means of a pivot member and comprising a retainer settled about this end for the purpose that when the hook is extended, the retainer facilitates retaining the hook to be leveled with the suspension bar.

### BRIEF DESCRIPTION OF THE DRAWINGS

The invention as well as a preferred mode of use, further objectives and advantages thereof, will best be understood by reference to the following detailed description of an illustrative embodiment when read in conjunction with the accompanying drawings, wherein:

FIG. 1 is an exploded view of a conventional hanging file folder;

FIG. 2 is a perspective view of the conventional hanging file folder;

FIG. 3 is a partial exploded view of the hanging file folder of the present invention;

FIG. 4 is a partial perspective view of the hanging file folder of the present invention;

FIG. 5 is a plane view of the hanging file folder of the present invention showing the hooks fully extended;

FIG. 6 is another plane view of the hanging file folder of the present invention showing the hooks collapsed;

FIG. 7 is one assembly drawing of the suspension bar, adjusting structure and one of the hooks according to the present invention;

FIG. 8 is another assembly drawing of the suspension bar, adjusting structure and one of the hooks according to the present invention;

FIG. 9 is yet another assembly drawing of the suspension bar, adjusting structure and one of the hooks according to the present invention; and

FIG. 10 is an applied view showing the hanging file folder of the present invention being hung in a hanging file frame assembly.

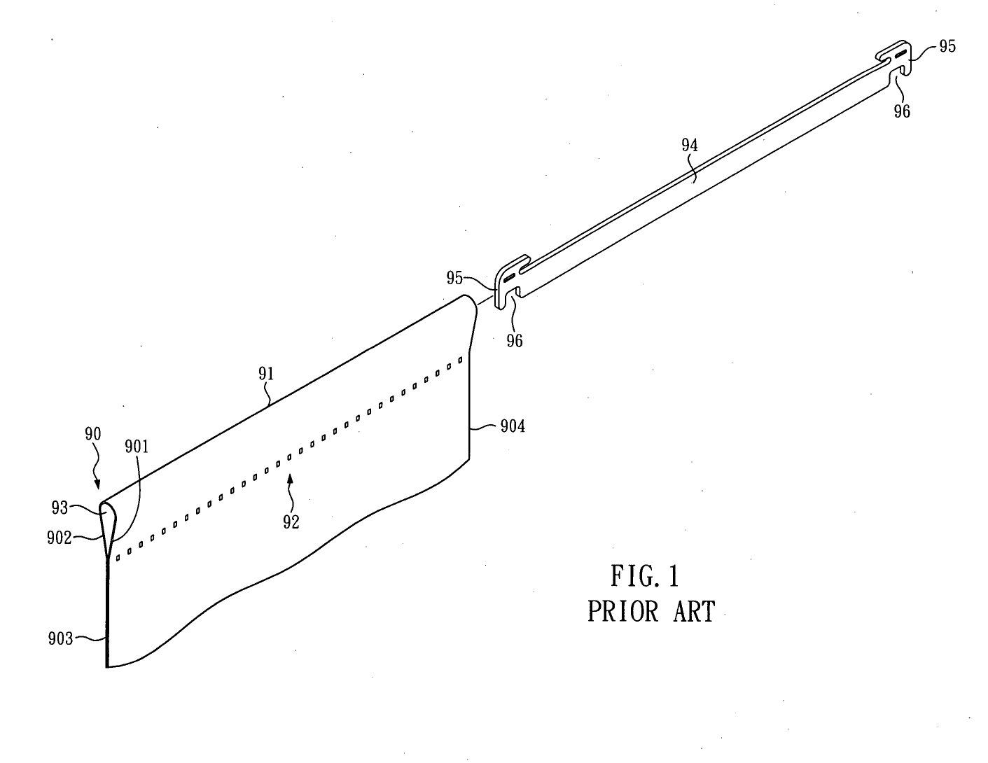

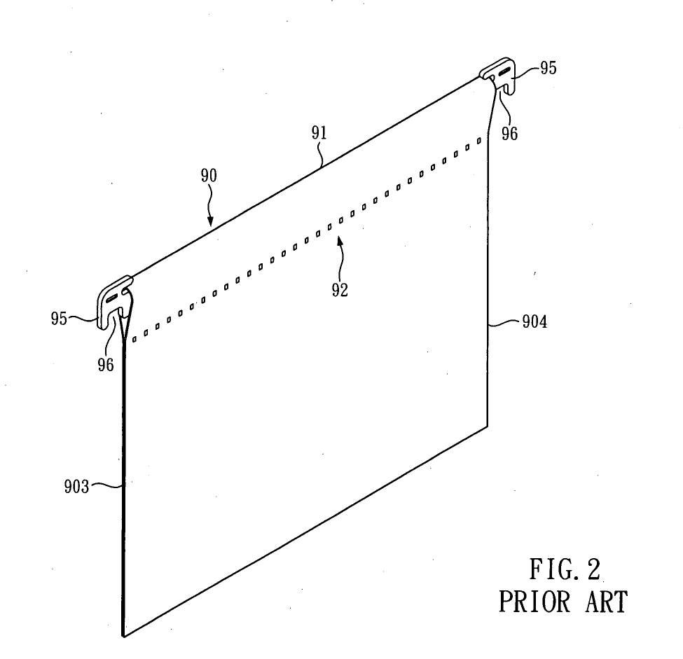

### DETAILED DESCRIPTION OF THE PREFERRED EMBODIMENT

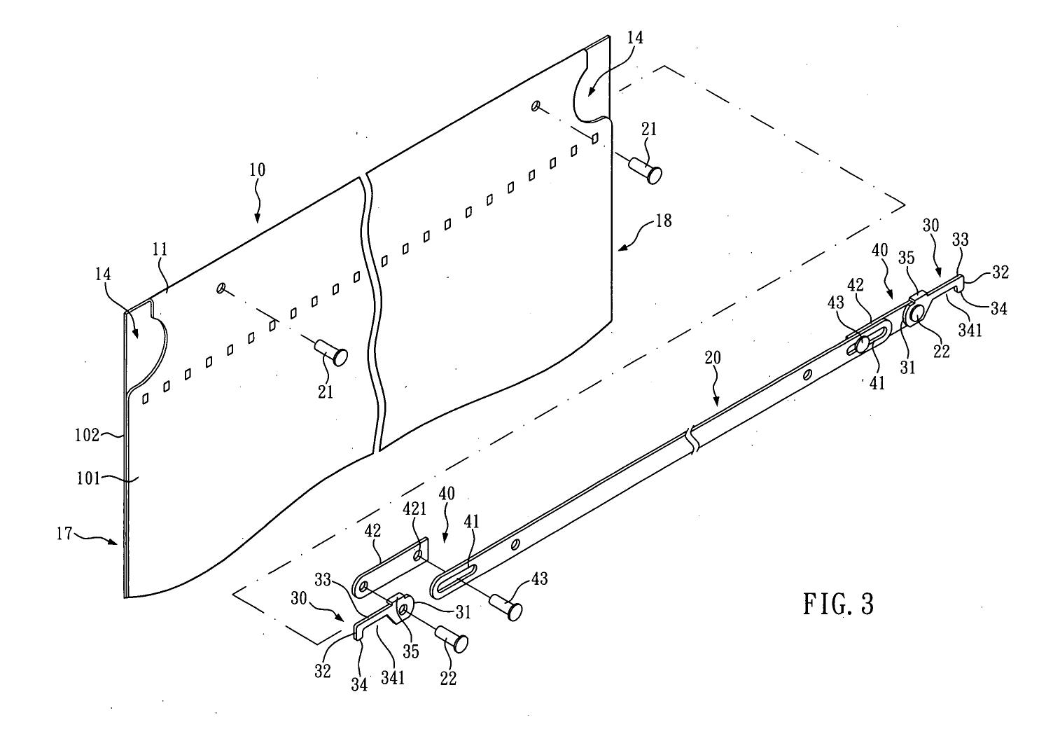

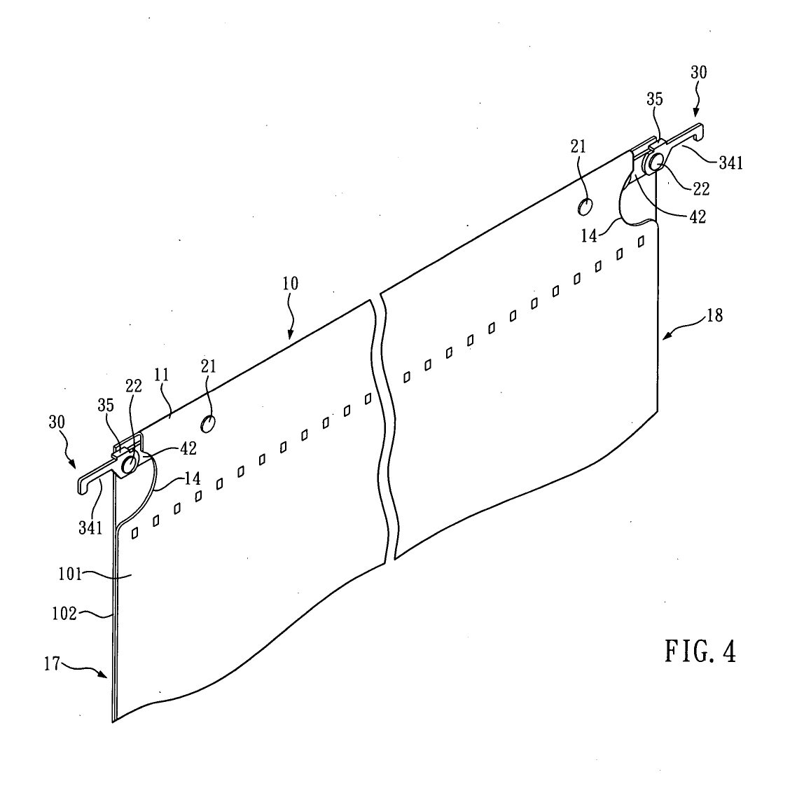

As shown in FIGS. 3 and 4, the hang file folder according to the present invention is primarily composed of a body portion 10 and a suspension bar 20.

The body portion 10 is substantially made by folding a board in to a shape that includes two opposite covers 101, 102 and a spine 11 situated therebetween. The suspension bar 20 is positioned between the covers 101, 102 near the spine 11 and fastened to the covers 101, 102 by means of a plurality of fasteners 21. Further, two notches 14 are provided at the cover 101 and are respectively positioned about the opposite edges 17, 18 of the cover 101 near the spine 11.

An adjusting structure 40 is provided at each of the ends of the suspension bar 20 for combining a hook 30 and the adjusting structure 40 comprises:

two slots 41 respectively provided at the opposite ends of the suspension bar 20, and

two shift arm 42 each having a bore 421 at one end thereof corresponding to a respective said slot 41 so that a fastener 43 can pierce through the slot 41 and the bore 421 to movably annex the shift arm 42 to the lateral of the suspension bar 20 with a predetermined protruding distance.

Further, each of the said shift arms 42 is connected to the hook 30 through a pivot member 22. The hook 30 comprises two opposite ends, namely a first end 31 and a second end 32, and two edges for connecting the first end 31 with the second end 32, namely a first edge 33 and a second edge 34, wherein the first end 31 is fastened to the shift arm 42 by the pivot member 22, and a retainer 35 projecting toward shift arms 42 is settled at the first edge 33 near the first end 31 while an opening 341 is provided at the second edge 34 of the hook 30.

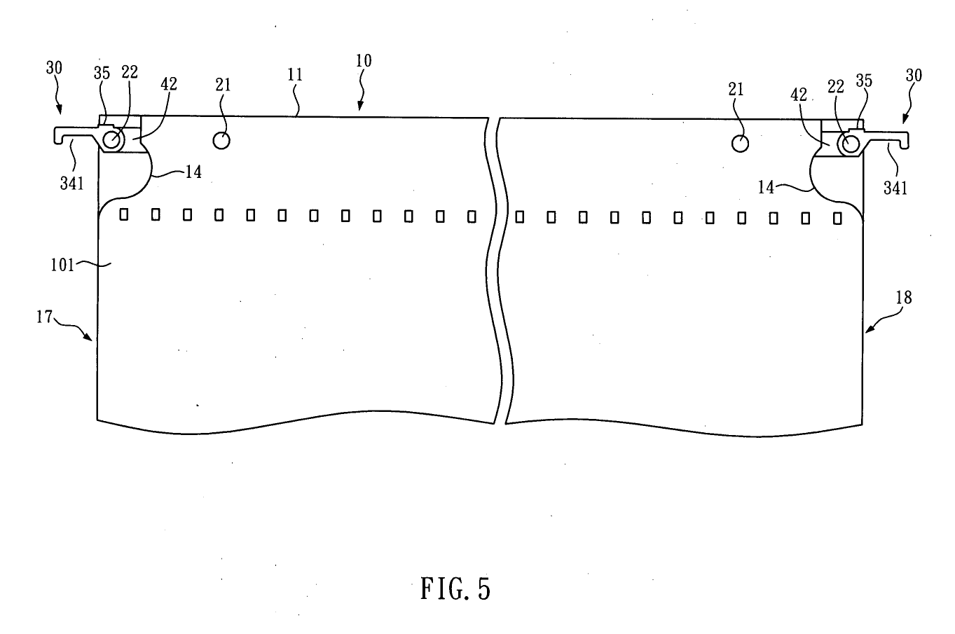

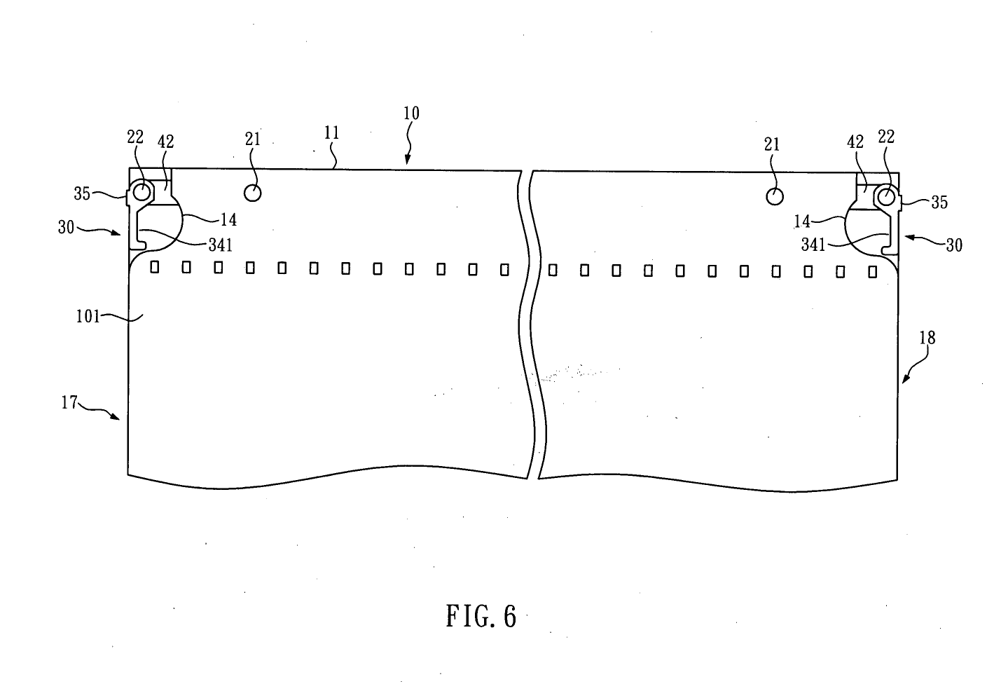

Thereupon, as shown in FIGS. 5 and 6, the hooks 30 are allowed revolving about the corresponding pivot members 22 toward or outward the proximal edges 17, 18 of the body portion 10.

Also, referring to FIG. 5, as the hooks 30 respectively revolve about the pivot members 22 toward the proximal edges 17, 18 of the body portion 10 to a collapsed position thereof, they can become perpendicular to the suspension bar 20 and be completely accommodated between the covers 101, 102. At this point, a user can easily get in touch with the hooks 14 30 and pull them to extend through the notches 14 provided on the cover 101.

In FIG. 6, as both hooks 30 revolve about the pivot members 22 outward the edges 17, 18 of the body portion 10 until the retainers 35 stop at the edge of the suspension bar 20, at this point, the hooks 30 are again leveled with the suspension bar 20 and jutting out from the edges 17, 18 of the body portion 10. Thereby, the disclosed folder can be hung in the hanging file frame assembly 50 by engaging the support rails 51, 52 with the openings 341 of the hooks.

Thus, the present invention is characterized by the collapsible hooks 30 arranged at the opposite ends of the suspension bar 20. When the hooks 30 are fully extended, the folder can be hung on the support rails 51, 52 of the hanging file frame assembly 50 thereby. When the folder is taken out from the hanging file frame assembly 50 for individual usage, the hooks 30 can be collapsed from the edges 17, 18 of the body portion 10 and stay between the cover 101, 102 so that the hooks 30 can be protected by the cover 101, 102 from undesirable impact and disturbance to the user caused by the extended hooks 30 can be therefore eliminated.

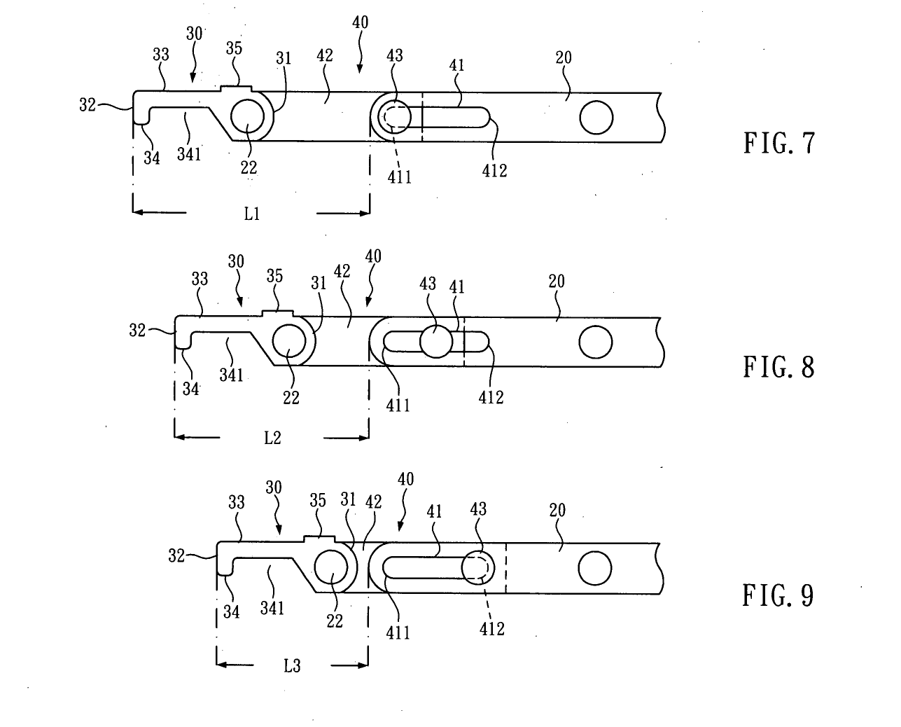

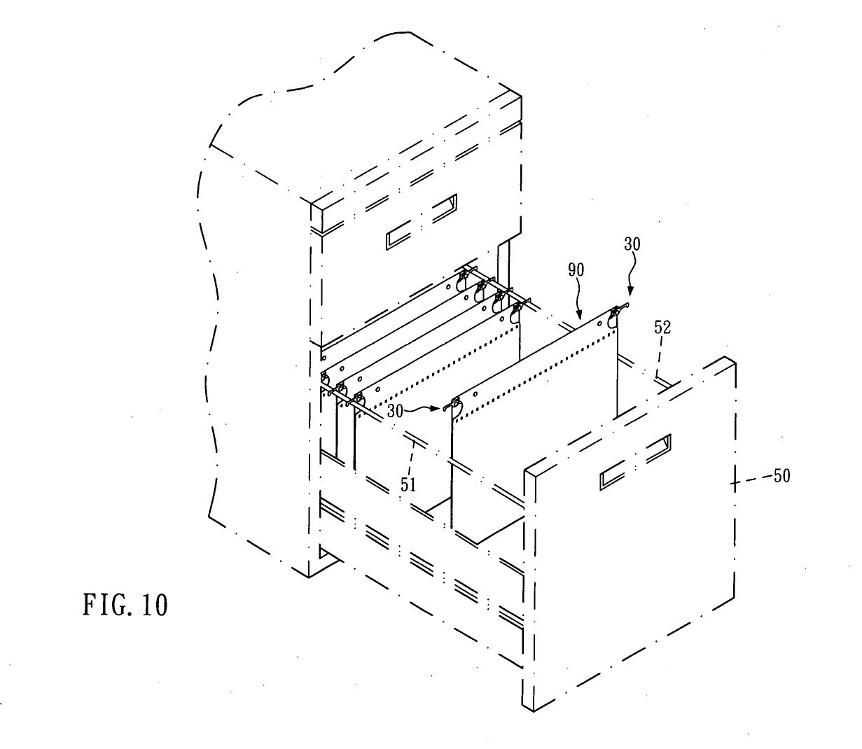

FIGS. 7, 8 and 9 are provided for illustrating the variation of the length of the suspension bar 20 accomplished by operating the adjusting structures 40. As shown in FIG. 7, the fastener 43 for combining the shift arm 42 and the suspension bar 20 is now in close contact with the first extreme 411 of the slot 41, and the present distance between the second end 32 of the hook 30 and the proximal end of the suspension bar 20 is designated as L1. In FIG. 8, the fastener 43 is now positioned at a predetermined location along the slot 41, and the present distance between the second end 32 of the hook 30 and the proximal end of the suspension bar 20 is designated as L2. According to FIG. 9, the fastener 43 is now in close contact with the second extreme 412 of the slot 41, and the present distance between the second end 32 of the hook 30 and the proximal end of the suspension bar 20 is designated in the drawing as L3. Hence, through FIGS. 7 to 9, it can be learned that by operating the adjusting structure 40, the stepless adjustment of the relative distance between the second end 32 of the hook 30 and the proximal end of the suspension bar 20 can be realized. Thereby, the suspension bar 20 can be adapted to diverse-sized folders, such as A3 folders, A4 folders, B5 folders and other folders of custom-made dimensions by operating and setting the adjusting structures 40 appropriately.

Although a particular embodiment of the invention has been described in detail for purposes of illustration, it will be understood by one of ordinary skill in the art that numerous variations will be possible to the disclosed embodiments without going outside the scope of the invention as disclosed in the claims.

What is claimed is:

1. A hanging file folder, which comprises:
a body portion, which is composed of two opposite covers and a spine jointing situated between the adjoining edges thereof;
a suspension bar, which is fastened between the covers by a plurality of fasteners near the spine, and is attached by two adjusting structures at the opposite ends thereof; and
two hooks, each having one end connected to one of the adjusting structures by means of a pivot member and comprising a retainer settled about this end for the purpose that when the hook is extended, the retainer facilitates retaining the hook to be leveled with the suspension bar.

2. The hanging file folder of claim 1, wherein each of the hooks comprises two opposite ends, namely a first end and a second end, and two edges for connecting the first end with the second end, namely a first edge and a second edge, wherein the first end is pivotally fastened to the shift arm, and a retainer is settled at the first edge near the first end.

3. The hanging file folder of claim 2, wherein an opening is provided at the second edge of the hook.

4. The hanging file folder of claim 1, wherein the hooks can be completely accommodated between the opposite covers of the body portion when being revolved to be perpendicular to the suspension bar.

5. The hanging file folder of claim 4, wherein two notches are provided at one of the covers and are respectively positioned about the opposite edges of the cover near the spine.

6. The hanging file folder of claim 1, wherein each said adjusting structure comprises two slots respectively provided at the opposite ends of the suspension bar, and two shift arm each having a bore at one end thereof corresponding to a respective said slot so that a fastener can pierce through the slot and the bore to fasten the shift arm to suspension bar.
